(19) United States
(12) Patent Application Publication
(10) Pub. No.: US 2025/0193114 A1
(43) Pub. Date: Jun. 12, 2025

(54) SYSTEM AND METHOD FOR CONTROLLING COMMUNICATION PROTOCOLS WITHIN A NETWORK BASED ON SMART CONTRACTS

(71) Applicant: SAMSUNG ELECTRONICS CO., LTD., Suwon-si (KR)

(72) Inventor: Ravi SHARMA, Noida (IN)

(73) Assignee: SAMSUNG ELECTRONICS CO., LTD., Suwon-si (KR)

(21) Appl. No.: 18/982,929

(22) Filed: Dec. 16, 2024

Related U.S. Application Data
(63) Continuation of application No. PCT/KR2024/015821, filed on Oct. 17, 2024.

(30) Foreign Application Priority Data
Dec. 7, 2023 (IN) 202311083528

(51) Int. Cl. H04L 45/52; H04L 47/20; H04W 12/06; H04W 76/10

(52) U.S. Cl. CPC H04L 45/52; H04L 47/20; H04W 12/06; H04W 76/10

(57) ABSTRACT

A method for controlling communication protocols within a network based on at least one smart contract, includes: executing the at least one smart contract to regulate communication between a set of devices in the network; based on an execution of the at least one smart contract: detecting one or more devices from the set of devices restricted to establish communication within the network; and enforcing one or more routing protocols, based on at least one of a term or a condition, which is specified in the at least one smart contract.

### CROSS-REFERENCE TO RELATED APPLICATIONS

This application is a by-pass continuation application of International Application No. PCT/KR2024/015821, filed on Oct. 17, 2024, which is based on and claims priority to Indian Patent Application number 202311083528, filed on Dec. 7, 2023, in the Indian Intellectual Property Office, the disclosures of which are incorporated by reference herein their entireties.

### BACKGROUND

### 1. Field

The disclosure relates to wireless communication, and more particularly, relates to a system and a method for controlling communication protocols within a network based on at least one smart contract.

### 2. Description of Related Art

In a network of connected devices (such as smartphones), once a connection is established, access to data/resources is provided within the network. This leads to unregulated access of data and resources of a device by other connected devices in the network. In these cases, the problem of unauthorized communication and uncontrolled usage of data/resource occurs. For example, in an Internet of Things (IoT) environment, multiple IoT devices are connected to a common network and are accessing data/resources from each other within the common network. For example, several devices are interconnected via Wireless Fidelity (Wi-Fi) hotspot and share data with each other. As a result of such connection, some devices are allowed with unregulated access to other devices' data and resources.

FIG. 1 illustrates a problem with existing data sharing system, according to the related art. As depicted in FIG. 1, a device 102 represents a device i.e., source of hotspot/data source. Furthermore, devices 104, 106, 108 are Wi-Fi capable devices connected to the hotspot of device 102. Further, a device 110 is a Wi-Fi capable device connected to the hotspot of device 108 and using the data of the device 102. Since the devices 104, 106, and 108 are connected to the hotspot of the device 102, there is no way to restrict their usage of data access. For example, the restriction may be that the device 104 can use up to 100 MB, the device 106 can use up to 200 MB, the device 108 can use up to 300 MB, and the device 110 can only connect with the devices 104, 106, 108 but cannot use the data. However, in the related art, the devices 104, 106, 108, 110 use unregulated data access and no control or limitations are there over data access. If the device 108 does not use any data from the device 102 and the device 110 uses data via the device 108, which is to be used by the device 108, not by the device 110.

Further, when devices are connected over the network, the authentication and access control are currently present only at the time of pairing or connection establishment. Once a device is connected, other devices are able to access the data over the connection session. For example, hotspot or Wi-Fi share connection requests are accepted, and thus, once connected, the data can be accessed or shared. When there are multiple connected devices, there is no mechanism in place that can control in which manner and extent the given access is utilized. If a device is paired, the mechanism of the related art is to provide access to paired device. Monitoring the requests generated by paired devices and accepting and rejecting these requests require real-time validation to check if a particular request should be attended to or not. However, such monitoring is not performed by the related art as they fail to govern the communication protocols. Further, if a device is paired, the device should only be allowed to connect but not necessarily access data and also not access unlimited data for unlimited time. However, the related art fail to provide such controls to a user for regulating the data access and resource sharing.

Furthermore, when the access control is performed at upper layers of a communication setup, authentication of the user, session validations, and other measures are taken to give access of the data to the connected devices. Once a device is connected, the access is given to that device for the duration of the connection/session, which may lead to undesired usage of that access and data. The related art fails to regulate the data access when the session and trust has been established.

Accordingly, there is a need for a system or a method for overcoming the above-identified problems.

The above information is presented as background information only to assist with an understanding of the disclosure. No determination has been made, and no assertion is made, as to whether any of the above might be applicable as prior art with regard to the disclosure.

### SUMMARY

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

According to an aspect of the disclosure, a method for controlling communication protocols within a network based on at least one smart contract, includes: executing the at least one smart contract to regulate communication between a set of devices in the network; based on an execution of the at least one smart contract: detecting one or more devices from the set of devices restricted to establish communication within the network; and enforcing one or more routing protocols, based on at least one of a term or a condition, which is specified in the at least one smart contract.

According to an aspect of the disclosure, a system for controlling communication protocols within a network based on at least one smart contract, includes: a memory; and at least one processor operatively coupled to the memory, the at least one processor being configured to: execute at least one smart contract to regulate communication between a set of devices in the network; based on an execution of the at least one smart contract: detect one or more devices from the set of devices that are restricted to establish communication within the network; and enforce one or more routing protocols based on at least one of a term or a condition, which is specified in the at least one smart contract.

To further clarify the advantages and features of the disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

These and other features, aspects, and advantages of the disclosure will become better understood when the following detailed description is read with reference to the accompanying drawings in which like characters represent like parts throughout the drawings, wherein:

FIG. 1 illustrates problems with a data sharing system of the related art;

FIG. 2 illustrates a system for controlling communication protocols within a network based on one or more smart contracts (at least one smart contract), according to an embodiment of the disclosure;

FIG. 3 illustrates a plurality of modules of the system at the device for controlling communication protocols within the network based on the one or more smart contracts, according to an embodiment of the disclosure;

FIGS. 4A and 4B illustrate operations of the system for controlling communication protocols within the network based on the one or more smart contracts, according to an embodiment of the disclosure;

FIGS. 5A and 5B illustrate flow charts depicting the working of an executing module, according to an embodiment of the disclosure;

FIG. 6 illustrates a flow chart depicting the working of a restricting module, according to an embodiment of the disclosure;

FIGS. 7A to 7C illustrate operations of an updating module, according to an embodiment of the disclosure;

FIG. 8 illustrates operations of the system for controlling the communication protocols within the network, according to an embodiment of the disclosure;

FIG. 9 illustrates a use case of the system for controlling the communication protocols within the network, according to an embodiment of the disclosure; and

FIG. 10 illustrates a method for controlling communication protocols within the network based on the one or more smart contracts, according to an embodiment of the disclosure.

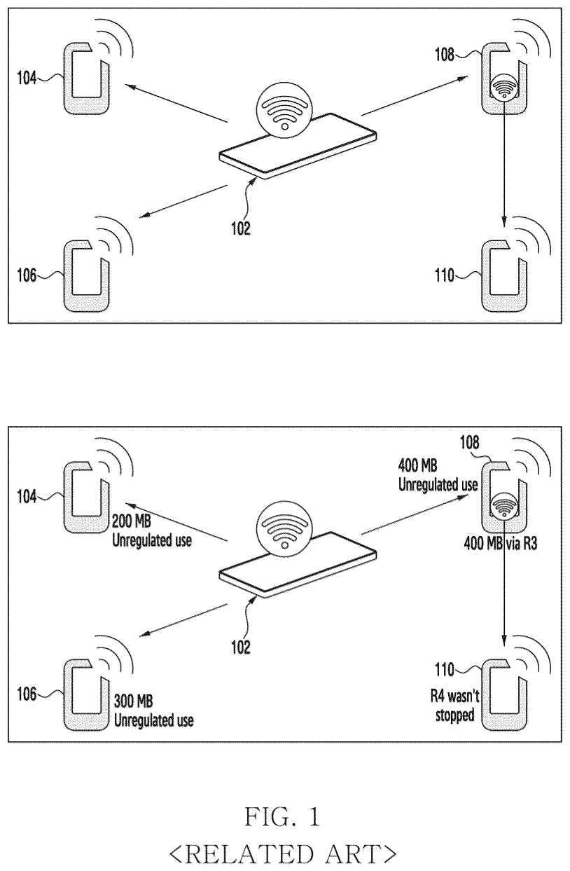

Further, skilled artisans will appreciate those elements in the drawings are illustrated for simplicity and may not have necessarily been drawn to scale. For example, the flow charts illustrate the method in terms of the most prominent operations involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Moreover, multiple functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

In addition, in the disclosure, in order to determine whether a specific condition is satisfied or fulfilled, an expression of more than or less than may be used, but this is only a description for expressing an example, and does not exclude description of more than or equal to or less than or equal to. A condition described as ‘more than or equal to’ may be replaced with ‘more than’, a condition described as ‘less than or equal to’ may be replaced with ‘less than’, and a condition described as ‘more than or equal to and less than’ may be replaced with ‘more than and less than or equal to’.

The term “unit” or “module” used in the disclosure refer to a hardware component such as a processor or a circuit, and/or a software component executed by a hardware component such as a processor.

A “unit”, “module” may be implemented by a program that is stored in a storage medium which may be addressed, and is executed by a processor. For example, a “unit”, “module” may be implemented by components such as software components, object-oriented software components, class components, and task components, processes, functions, attributes, procedures, sub-routines, segments of a program code, drivers, firmware, a micro code, a circuit, data, a database, data structures, tables, arrays and parameters.

It is to be understood that the singular forms “a,” “an,” and “the” include plural referents unless the context clearly dictates otherwise. Thus, for example, reference to “a component surface” includes reference to one or more of such surfaces.

In various examples of the disclosure described below, a hardware approach will be described as an example. However, since various embodiments of the disclosure may include a technology that utilizes both the hardware-based and the software-based approaches, they are not intended to exclude the software-based approach.

As used herein, the terms referring to merging (e.g., merging, grouping, combination, aggregation, joint, integration, unifying), the terms referring to signals (e.g., packet, message, signal, information, signaling), the terms referring to resources (e.g. section, symbol, slot, subframe, radio frame, subcarrier, resource element (RE), resource block (RB), bandwidth part (BWP), opportunity), the terms used to refer to any operation state (e.g., step, operation, procedure), the terms referring to data (e.g. packet, message, user stream, information, bit, symbol, codeword), the terms referring to a channel, the terms referring to a network entity (e.g., distributed unit (DU), radio unit (RU), central unit (CU), control plane (CU-CP), user plane (CU-UP), O-DU-open radio access network (O-RAN) DU), O-RU (O-RAN RU), O-CU (O-RAN CU), O-CU-UP (O-RAN CU-CP), O-CU-CP (O-RAN CU-CP)), the terms referring to the components of an apparatus or device, or the like are only illustrated for convenience of description in the disclosure. Therefore, the disclosure is not limited to those terms described below, and other terms having the same or equivalent technical meaning may be used therefor. Further, as used herein, the terms, such as ‘˜ module’, ‘˜ unit’, ‘˜ part’, ‘˜ body’, or the like may refer to at least one shape of structure or a unit for processing a certain function.

Further, throughout the disclosure, an expression, such as e.g., ‘above’ or ‘below’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {′C′, ‘D’, or ‘C’ and ‘D’}.

The disclosure describes various embodiments using terms used in some communication standards (e.g., 3rd Generation Partnership Project (3GPP), extensible radio access network (xRAN), open-radio access network (O-RAN) or the like), but it is only of an example for explanation, and the various embodiments of the disclosure may be easily modified even in other communication systems and applied thereto.

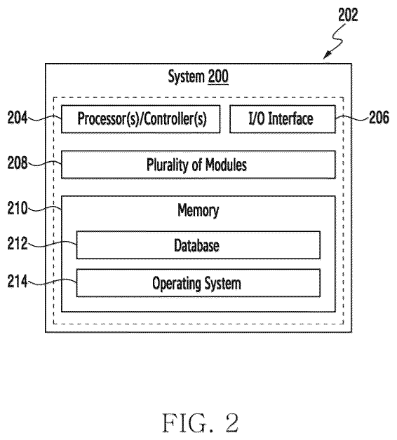

FIG. 2 illustrates a block diagram of a system 200 for controlling communication protocols within a network based on one or more smart contracts (at least one smart contract), according to an embodiment of the disclosure. In an embodiment of the disclosure, the communication protocols are a set of rules and conventions that define how data is transmitted and received over a network. In an embodiment of the disclosure, the one or more smart contracts are self-executing contracts with the terms of the agreement directly written into the code. The one or more smart contracts run on blockchain platforms, where they automatically enforce and execute the terms of the contract when predefined conditions are met. Further, the system 200 is implemented in a device 202. Examples of the device 202 may include but are not limited to, a smartphone, a laptop, a camera device, a smartwatch, and the like.

The system 200 may include one or more processors/controllers (at least one processor or at least one controller) 204, an Input/Output (I/O) interface 206, a plurality of modules 208, and a memory 210.

In an embodiment, the one or more processors/controllers 204 may be operatively coupled to each of the respective I/O interface 206, the plurality of modules 208, and the memory 210. In one embodiment, the one or more processors/controllers 204 may include at least one data processor for executing processes in a Virtual Storage Area Network. The one or more processors/controllers 204 may include specialized processing units such as integrated system (bus) controllers, memory management control units, floating point units, graphics processing units, digital signal processing units, etc. In one embodiment, the one or more processors/controllers 204 may include a Central Processing Unit (CPU), a Graphics Processing Unit (GPU), or both. The one or more processors/controllers 204 may be one or more general processors, digital signal processors, application-specific integrated circuits, field-programmable gate arrays, servers, networks, digital circuits, analog circuits, combinations thereof, or other now known or later developed devices for analyzing and processing data. The one or more processors/controllers 204 may execute a software program, such as code generated manually (i.e., programmed) to perform the desired operation. In an embodiment of the disclosure, the processors/controllers may be a general-purpose processor, such as the CPU, an Application Processor (AP), or the like, a graphics-only processing unit such as the GPU, a Visual Processing Unit (VPU), and/or an Artificial Intelligence (AI)-dedicated processor, such as a Neural Processing Unit (NPU).

The one or more processors/controllers 204 may be disposed in communication with one or more input/output (I/O) devices via the respective I/O interface 206. The I/O interface 206 may employ communication code-division multiple access (CDMA), high-speed packet access (HSPA+), global system for mobile communications (GSM), long-term evolution (LTE), WiMax, or the like, etc.

The one or more processors/controllers 204 may be disposed in communication with a communication network via a network interface. In an embodiment, the network interface may be the I/O interface 206. The network interface may connect to the communication network to enable the connection of the device 202 with other devices. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, and the like.

In some embodiments, the memory 210 may be communicatively coupled to the one or more processors/controllers 204. The memory 210 may be configured to store data, and instructions executable by the one or more processors/controllers 204. The memory 210 may include but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 210 may include a cache or random-access memory for the one or more processors/controllers 204. In alternative examples, the memory 210 is a part of the one or more processors/controllers 204, such as a cache memory of a processor, the system memory, or other memory. In some embodiments, the memory 210 may be an external storage device or database for storing data. The memory 210 may be operable to store instructions executable by the one or more processors/controllers 204. The functions, acts, or tasks illustrated in the figures or described may be performed by the programmed processor/controller for executing the instructions stored in the memory 210. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

In some embodiments, the plurality of modules 208 may be included within the memory 210. The memory 210 may further include a database 212 to store data. The plurality of modules 208 may include a set of instructions that may be executed to cause the system 200 to perform any one or more of the methods/processes disclosed herein. The plurality of modules 208 may be configured to perform the operations of the disclosure using the data stored in the database 212 for controlling communication protocols within the network based on the one or more smart contracts, as discussed herein. In an embodiment, each of the plurality of modules 208 may be a hardware unit that may be outside the memory 210. Further, the memory 210 may include an operating system 214 for performing one or more tasks of the system 200, as performed by a generic operating system in the communications domain. In one embodiment, the database 212 may be configured to store the information as required by the plurality of modules 208 and the one or more processors/controllers 204 for controlling communication protocols within the network based on the one or more smart contracts.

In an embodiment of the disclosure, at least one of the plurality of modules 208 may be implemented through a machine learning (ML) model. A function associated with the ML may be performed through the non-volatile memory, the volatile memory, and the one or more processors/controllers 204.

In an embodiment, the I/O interface 206 may enable input and output to and from the system 200 using suitable devices such as, but not limited to, a display, a keyboard, a mouse, a touch screen, a microphone, a speaker, and so forth.

Further, the disclosure also contemplates a computer-readable medium that includes instructions or receives and executes instructions responsive to a propagated signal. Further, the instructions may be transmitted or received over the network via a communication port or interface or using a bus. The communication port or interface may be a part of the one or more processors/controllers 204 or may be a separate component. The communication port may be created in software or may be a physical connection in hardware. The communication port may be configured to connect with a network, external media, the display, or any other components in the device 202, or combinations thereof. The connection with the network may be a physical connection, such as a wired Ethernet connection, or may be established wirelessly. Likewise, the additional connections with other components of the device 202 may be physical or may be established wirelessly. The network may alternatively be directly connected to the bus. For the sake of brevity, the architecture, and standard operations of the operating system 214, the memory 210, the database 212, the one or more processors/controllers 204, and the I/O interface 206 are not discussed in detail.

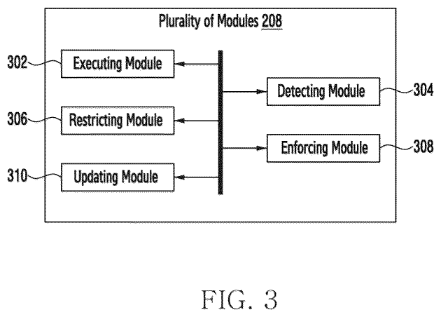

FIG. 3 illustrates a block diagram of the plurality of modules 208 of the system 200 at the device 202 for controlling communication protocols within the network based on the one or more smart contracts, according to an embodiment of the disclosure. In an embodiment of the disclosure, the plurality of modules 208 may include but is not limited to, an executing module 302, a detecting module 304, a restricting module 306, an enforcing module 308, and an updating module 310. The plurality of modules 208 may be implemented by way of suitable hardware and/or software applications.

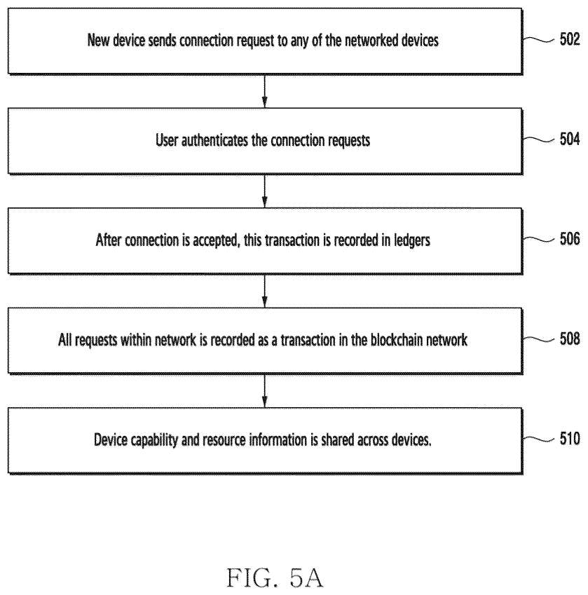

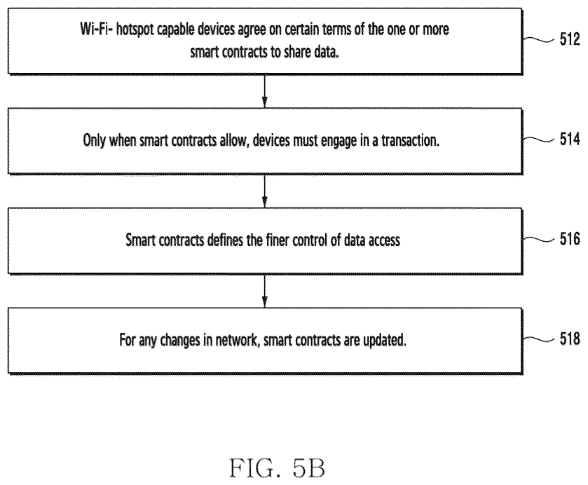

The executing module 302 may be configured to execute/manage the one or more smart contracts to regulate communication (traffic or resource allocation) between a set of devices in the network. In an embodiment of the disclosure, the network is a blockchain-based network. In an embodiment of the disclosure, the one or more smart contracts correspond to an agreement between two parties which is bound to be executed when certain conditions are met. The one or more smart contracts are stored in the blockchain and are enforced automatically when conditions are met. No party can back away from the contract as they can't alter the one or more smart contracts. In executing the one or more smart contracts, the executing module 302 may be configured to regulate traffic between the set of devices based on execution of the one or more contracts. The executing module 302 may further be configured to allocate one or more resources to the set of devices based on execution of the one or more contracts. Furthermore, the executing module 302 may be configured to regulate data sharing between the set of devices based on execution of the one or more contracts. For example, a mobile A (source) is sharing its data via hotspot to 3 other mobiles (sink) which are connected to the source. The disclosure can control which mobile (sink) can only connect but cannot access data, which sink can access data, and regulate the access of data for each sink. Further, the executing module 302 may be configured to regulate a bandwidth associated with data sharing between the set of devices based on execution of the one or more contracts. The executing module may be configured to regulate a speed of data sharing between the set of devices based on execution of the one or more contracts. Further, the executing module may be configured to regulate a duration of data sharing between the set of devices based on execution of the one or more contracts. The details on the operation of the executing module 302 have been elaborated in subsequent paragraphs by using at least with reference to FIGS. 5A and 5B.

Further, the detecting module 304 may be configured to detect, based on execution of the one or more smart contracts, one or more devices from the set of devices that are restricted to establish communication within the network. In an embodiment of the disclosure, the one or more devices are devices with Wireless Fidelity (Wi-Fi), telecommunication capabilities (such as Third Generation (3G), 4G, 5G, 6G, and the like), Bluetooth™ capabilities, or a combination thereof.

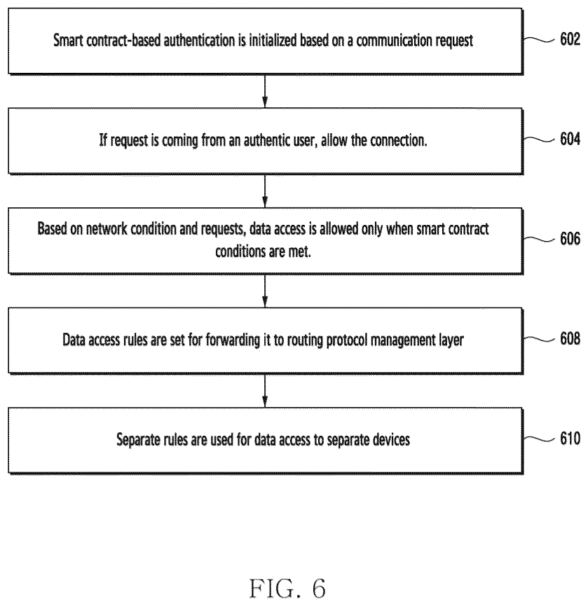

Furthermore, the restricting module 306 may be configured to restrict the detected one or more devices from establishing the communication or data sharing within the network. In an embodiment of the disclosure, the detected one or more devices are restricted from establishing the communication or data sharing within the network unless authorized by the one or more smart contracts. The details on the operation of the restricting module 306 have been elaborated in subsequent paragraphs by using at least with reference to FIG. 6.

In an embodiment of the disclosure, the enforcing module 308 may be configured to enforce or monitor, based on execution of the one or more smart contracts, one or more routing protocols, based on at least one of a term or a condition, which is specified in the one or more smart contracts.

Further, the executing module 302 may be configured to receive a connection request from a new device to join the network. The executing module 302 may be configured to generate one or more new smart contracts for the new device based on the received connection request. The executing module 302 may further be configured to authenticate the identity of the new device based on the generated one or more new smart contracts. Further, the executing module 302 may be configured to (dynamically) update one or more routing tables associated with the set of devices upon authenticating the identity of the new device. The executing module 302 may be configured to regulate the communication between the set of devices and the new device in the network based on the (dynamically) updated one or more routing tables. The working of executing module 302 have been elaborated in subsequent paragraphs by using at least with reference to FIGS. 5A and 5B.

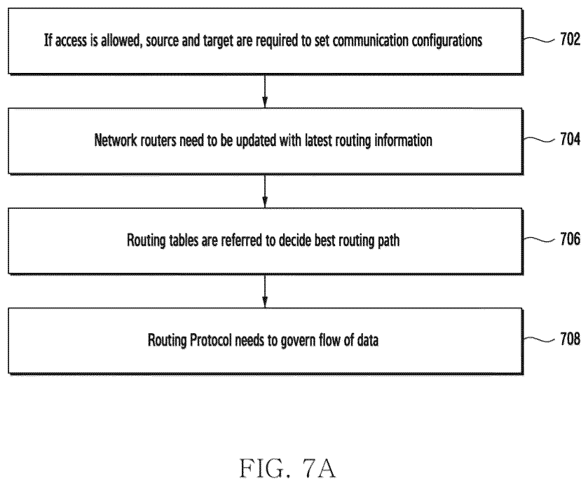

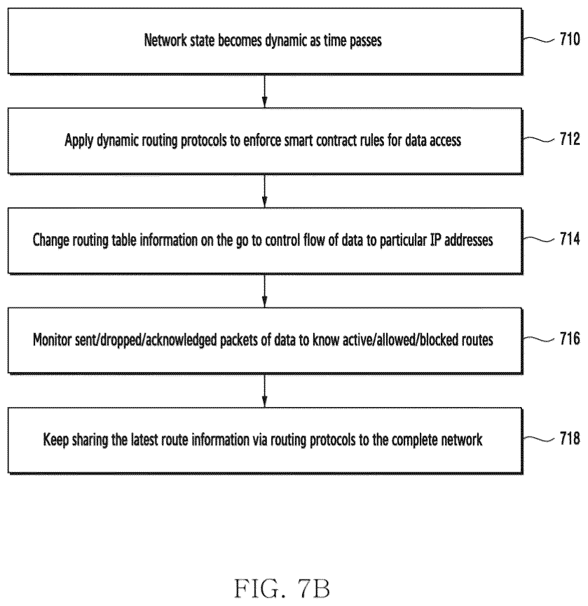

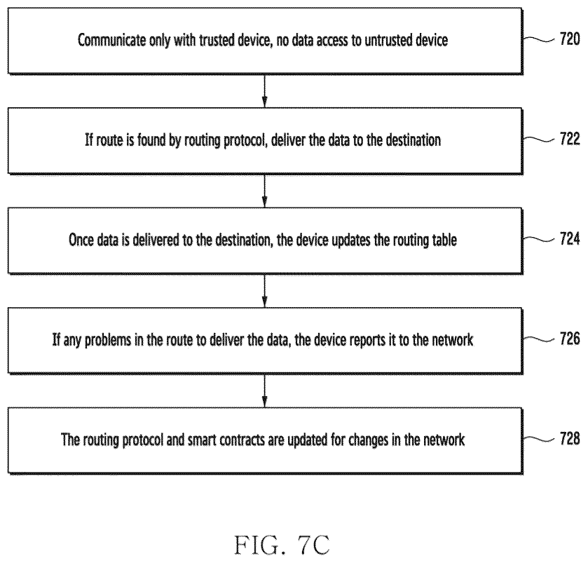

Further, the updating module 310 may be configured to update one or more routing tables associated with the set of devices within the network based on changes in the one or more smart contracts. In updating the one or more routing tables, the updating module 310 may be configured to detect creation, modification, termination, or any combination thereof of the one or more smart contracts within the network. Further, the updating module 310 may be configured to (dynamically) update the one or more protocol tables based on detected creation, modification, termination, or any combination thereof of the one or more smart contracts. The updating module 310 may be configured to optimize the regulation of communication between the set of devices based on the (dynamically) updated one or more protocol tables. In an embodiment of the disclosure, the regulation of communication between the set of devices is optimized by optimizing network performance and resource allocation based on the updated one or more routing tables. The details on the operation of the updating module 310 have been elaborated in subsequent paragraphs by using at least with reference to FIGS. 7A to 7C.

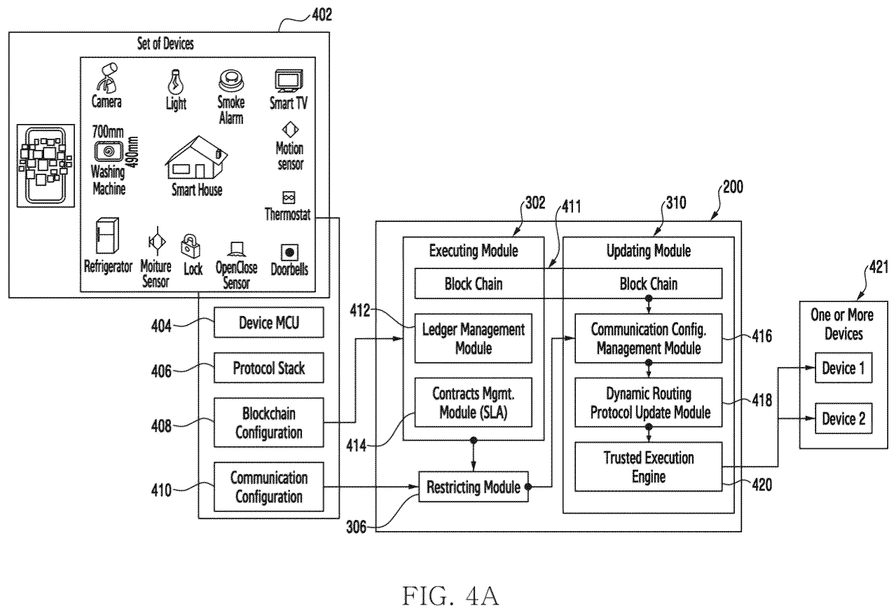

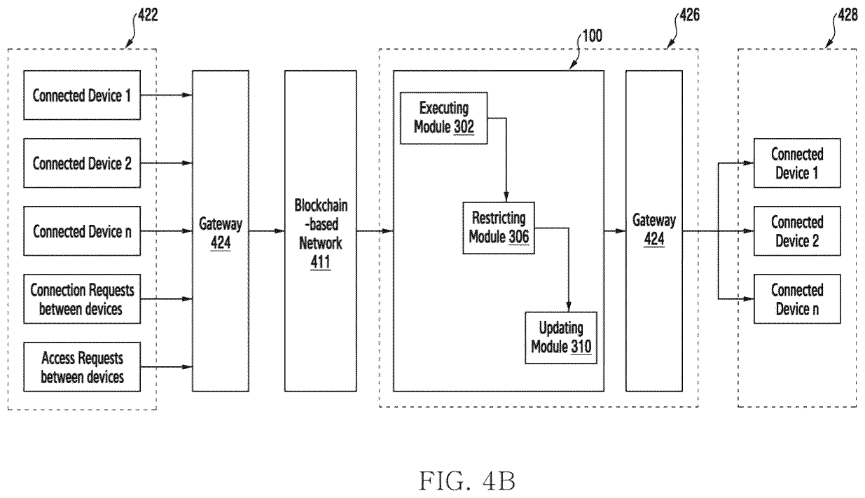

The details on controlling communication protocols within the network based on the one or more smart contracts have been elaborated in subsequent paragraphs by using at least with reference to FIGS. 4A and 4B, 8 and 9.

FIGS. 4A and 4B illustrate block diagrams depicting an operation of the system 200 for controlling communication protocols within the network based on the one or more smart contracts, according to an embodiment of the disclosure. For the sake of brevity, FIGS. 4A and 4B are explained together. The details on controlling communication protocols within the network based on the one or more smart contracts are explained with reference to FIG. 2.

In an embodiment of the disclosure, the device 202 acts as a mediator between the set of devices. Further, the system 200 regulates communication according to the established contracts and monitors the contract terms, and enforces routing protocols accordingly. As depicted in FIG. 4A, each of the set of devices 402 includes a device Microcontroller Unit (MCU) 404, a protocol stack 406, a blockchain configuration 408, and a communication configuration 410. In an embodiment of the disclosure, the device MCU 404 refers to an MCU embedded within the device. Further, the protocol stack 406 is a set of protocols that work together to provide comprehensive networking or communication functionality. In an embodiment of the disclosure, the blockchain configuration 408 corresponds to the setup and arrangement of various parameters, settings, and components within the blockchain-based network 411. The communication configuration 410 refers to the setup and arrangement of various parameters and settings that determine how the set of devices or systems communicate with each other within the blockchain-based network 411.

In an embodiment of the disclosure, the executing module 302 may include a ledger management module 412 and a contracts management module 414. The details on the ledger management module 412 and the contracts management module 414 have been elaborated in subsequent paragraphs by using at least with reference to FIGS. 5A and 5B. The executing module 302 may be configured to perform creation, management, regulation, and execution of the one or more smart contracts for inter-device communication in the connected network. The executing module 302 may also be configured to manage and execute the one or more smart contracts within the network to handle the creation, verification, and enforcement of contractual agreements between network devices for communication. Further, the restricting module 306 may be configured to govern the data and resource access based on the one or more smart contracts. Also, the restricting module 306 may be configured to authenticate the set of devices based on the one or more smart contracts. In an embodiment of the disclosure, the restricting module 306 may be configured to control/restrict the set of devices with Wi-Fi capabilities from establishing communication or data sharing within a hotspot without proper authorization from the smart contract. This ensures network security by controlling/preventing unauthorized access and communication. Further, the updating module 310 may include a communication configuration management module 416, a dynamic routing protocol update module 418, and a trusted execution engine 420. The details on the communication configuration management module 416, the dynamic routing protocol update module 418 and the trusted execution engine 420 have been elaborated in subsequent paragraphs by using at least with reference to FIGS. 7A to 7C. The updating module 310 may be configured to regulate data access by controlling communication protocol, routing table information, and allowing only valid configurations as per the one or more contracts. In an embodiment of the disclosure, the updating module 310 may be configured to manage configuration protocol and regulate communication. e.g., the routing protocol table is continuously updated based on the contractual agreements. As contracts are created, modified, or terminated, the routing protocol table is adjusted to reflect the changes. This may ensure optimal network performance by regulating resources and minimizes potential vulnerabilities. Based on established trust and rules, data access is provided to one or more devices 421 i.e., device 1 and device 2 separately and different extent of access is given to each device 1 and device 2.

When a new device is connected in the blockchain-based network 411, the blockchain-based network 411 is updated to add the new device to the list of connected devices, and new smart contracts are generated at each device for communication with the new device and shared within the blockchain-based network 411. When a request for data access is received by the system 200, the one or more smart contracts are used to establish the authenticity of the requester. Further, the data access rules are decided based on the one or more smart contracts. The data access rules are enforced by changing the routing tables of each device (dynamically). Also, as the contracts and network change, the change is reflected to routing tables. The final rules are executed within trusted devices and data is shared amongst the set of devices.

As shown in FIG. 4B, the reference numeral 422 shows a set of connected devices (i.e., connected device 1, connected device 2, and connected device n), connection requests between the set of devices, and access requests between the set of devices. In an embodiment of the disclosure, the set of connected devices becomes part of the blockchain-based network 411 via a gateway 424. Each new connection in the network, adds a new device/node in the blockchain-based network 411. All connection and data access requests are recorded as transactions in the blockchain-based network 411.

Further, the reference numeral 426 shows managing smart contracts, generating access regulations, and enforcing access by controlling communication (routing) protocol. In an embodiment of the disclosure, all devices create smart contracts which are stored in blockchain-based network 411. Based on smart contracts, access control, and regulations are defined. Further, access regulations are enforced by controlling the communication routing protocol. Based on routing information, communication, and data access/packet exchange takes place only for trusted devices. Further, at 428, separate access is provided to separate devices based on smart contracts rules.

FIGS. 5A and 5B illustrate flow charts depicting the working of the executing module 302, according to an embodiment of the disclosure. For the sake of brevity, FIGS. 5A and 5B are explained together. Functionalities of the executing module 302 are already explained with reference to FIG. 3.

Details on the working of the ledger management module 412 are explained with reference to FIG. 5A. For example, devices A, B, and C are connected to a common network. Now device D requests to join the same network. Further, after the user's approval and device D's authentication, the connection is established. Then all nodes/devices may have to update their ledgers to add this transaction “D joined the network”.

At operation 502, a new device sends a connection request to any of the networked devices. At operation 504, the user authenticates the connection requests. At operation 506, after the connection request is accepted, this transaction is recorded in ledgers. All requests within the network are recorded as a transaction in the blockchain, at operation 508. At operation 510, device capability and resource information are shared across devices. The device capability and resource information table to be shared across for smart contract agreements is shown in Table 1.

TABLE 1

| Device ID | Type | Capabilities |
|---|---|---|
| Mobile 1 | Mobile | 5G, Wi-Fi, Bluetooth ™ |
| Mobile 2 | Mobile | 4G, Wi-Fi, Bluetooth ™ |
| Mobile 3 | Mobile | 2G, Bluetooth ™ |

Further, details on the working of the contracts management module 414 are explained with reference to FIG. 5B. At operation 512, the Wi-Fi/Hotspot capable devices agree on certain terms of the one or more smart contracts to share data. Further, at operation 514, the devices must engage in a transaction if the one or more smart contracts allow. At operation 516, the one or more smart contracts define the finer control of data access. For any changes in the network, the one or more smart contracts are updated, at operation 518.

FIG. 6 illustrates a flow chart depicting the working of the restricting module 306, according to an embodiment of the disclosure. Functionalities of the restricting module 306 are already explained with reference to FIG. 3.

At operation 602, the smart contract-based authentication is initialized based on the communication request. At operation 604, if the communication request is coming from an authentic user, the connection is allowed. At operation 606, based on network conditions and requests, data access is allowed only when smart contract conditions are met. At operation 608, data access control rules are set for forwarding it to routing a protocol management layer. Example of the data access control rules and access regulations are shown in Table 2. Further, at operation 610, separate contracts (i.e., separate rules) are used for providing data access to different devices.

TABLE 2

| Device 1 | | | | |
|---|---|---|---|---|
| Attributes | Device 2 | | Device 3 | Device 4 |
| Connection | YES | | NO | YES |
| Data access | YES | | NO | NO |
| Time limit | 5 | Min | NA | NA |
| Data limit (available data > 1 GB) | 200 | MB | NA | NA |
| Data limit (available data < 1 GB) | 100 | MB | NA | NA |

FIGS. 7A to 7C illustrate flow charts depicting the working of the updating module 310, according to an embodiment of the disclosure. Functionalities of the updating module 310 are already explained with reference to FIG. 3.

Details on the working of the communication configuration management module 416 are explained with reference to FIG. 7A. For example, if data access is allowed between a hotspot source and the user, the hotspot source device is required to set Wi-Fi hotspot profile configurations. For example, the Wi-Fi hotspot profile configurations may include a frequency band, an authentication setting, priority settings, traffic monitoring settings, Mac address control-parental control, an authentication method, server settings [If authentication is done via server], authentication server IP address, port, shared secret, and the like. Further, the hotspot user is required to establish contact and maintain it using a Wi-Fi profile. Furthermore, a routing decision is made by referring routing tables to determine the best path for data sharing. For example, components of the routing table include a routing protocol, a type of route, an address of destination, an address of source/metric, an address of a next router, time since last update of route information, interface through which the next router can be reached, and the like. For example, the routing table information O E2 150.150.0.0 [160/5] via 131.119.254.6, 0:01:00, Ethernet2 O E2 192.68.132.0 [160/5] via 131.119.254.6, 0:00:59, Ethernet2, and O E2 130.130.0.0 [160/5] via 131.119.254.6, 0:00:59, Ethernet2. For example, when the nodes/devices are A, B, C, D, E, and F, one more possible routes to reach from A to B are ACB and ADEB.

At operation 702, if access is allowed between the hotspot source and the user, the hotspot source and target user are required to set communication configurations. At operation 704, the network routers are required to be updated with the latest routing information. Further, at operation 706, the routing tables are referred to decide best routing path. At operation 708, the routing protocol is required to govern the flow of data.

Details on the working of the dynamic routing protocol update module 418 are explained with reference to FIG. 7B. In an embodiment of the disclosure, the routing protocol controls the flow of data at a network layer. The routing protocol regulates the data flow from source to destination by controlling the routing of packets. Further, the routing protocol restricts the data access as per smart contract rules by changing routing protocols. Furthermore, the routing protocol maintains and monitors routing table information in the network to update data access control on the go. Also, the routing protocol determines the path of a packet through the network.

In an embodiment of the disclosure, the dynamic routing protocol update module 418 performs a set of functions, such as discovering remote networks, maintaining up to date routing information, selecting the best path for the destination network, finding a new path if the older path doesn't exist anymore, and the like. At operation 710, the network state becomes dynamic as time passes. Further, the attributes are monitored, such that rules can be triggered. At operation 712, dynamic routing protocols are applied to enforce smart contract rules for data access. At operation 714, the routing table information is changed to control the flow of data to a particular Internet Protocol (IP) address. Further, at operation 716, sent/dropped/acknowledged packets of data are monitored to determine active/allowed/blocked routes. At operation 718, the dynamic routing protocol update module 418 keeps sharing the latest route information via routing protocols to the complete network.

The dynamic routing protocol update module 418 also performs packet processing at each router. In each packet, there is a destination address. The routing protocol maintains routing tables to determine the path to the destination. Further, the parsing routing table leads to the determination of the next hop and exit interface. In an embodiment of the disclosure, the IP packet is updated with the next hop address and new checksums, such that the updated IP packet is transmitted via the interface.

For example, the routing table includes a path from device A to device B allowing the data access from device A to device B. The updating module 310 updates the routing table, such that no path to B exists. As a result, the data access from device A to device B is not allowed.

Details on the working of the trusted execution engine 420 are explained with reference to FIG. 7C. At operation 720, the device can communicate only with “trusted” device as allowed by the one or more smart contracts i.e., no data access to untrusted devices. At operation 722, if a route is found by the routing protocol, the device delivers the data to the destination. Once data is delivered to the destination, the device updates the routing table, so metering is done properly, at operation 724. At operation 726, if any problems in the route to deliver the data, the device reports it to the network. Furthermore, at operation 728, the routing protocol and smart contracts are updated for changes in the network.

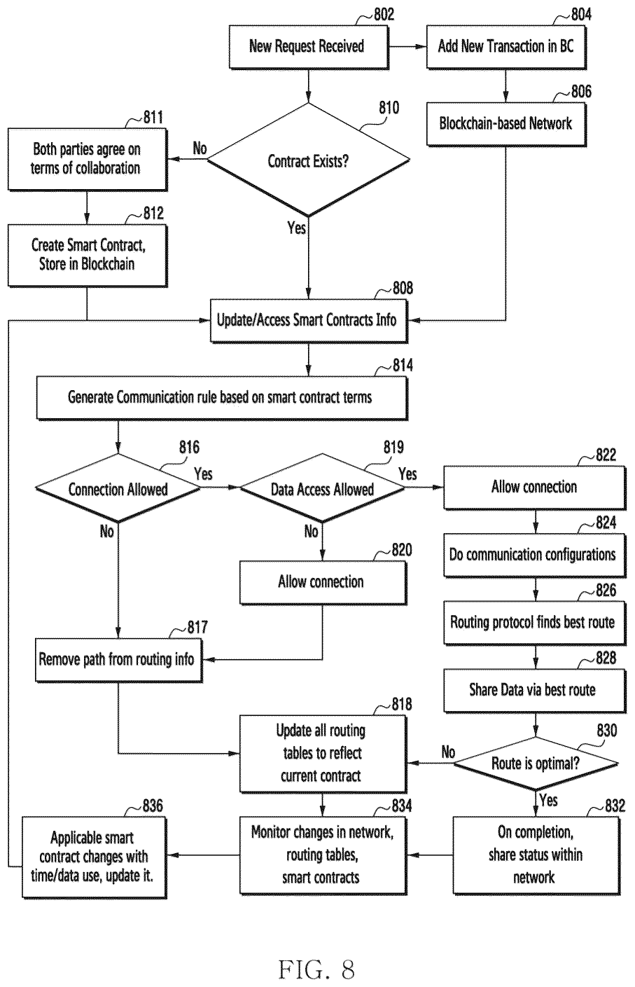

FIG. 8 illustrates a flow chart depicting the operation of the system 200 for controlling the communication protocols within the network, according to an embodiment of the disclosure. The details on the working of the system 200 to control the communication protocols within the network have been explained with reference to FIG. 3.

At 802, the system 200 receives a new request from the device. Further, at operation 804, the system 200 adds a new transaction in the blockchain-based network 806. At operation 808, the system 200 updates/accesses the information of the one or more smart contracts. Further, at operation 810, the system 200 determines whether the one or more contracts exist. If the output of operation 810 is yes, operation 808 is performed. If the output of operation is no, both parties (source device and target device) agree on terms of collaboration at operation 811. At operation 812, the system 200 creates the one or more smart contracts and stores the created one or more smart contracts in the blockchain-based network 806. Further, operation 808 is repeated.

At operation 814, the system 200 generates the communication rule based on the terms of the one or more smart contracts. Further, at operation 816, the system 200 determines if the connection is allowed. If the output of operation 816 is no, the system 200 removes the path from the routing information, at operation 817. Further, at operation 818, the system 200 updates all routing tables to reflect a current smart contract. If the output of operation 816 is yes, the system 200 determines if the data access is allowed, at operation 819. If the output of operation 819 is no, the system 200 allows the connection at operation 820. Further, if the output of operation 819 is yes, then the system 200 allows connection at operation 822. Further, at operation 824, the system 200 performs communication configurations. At operation 826, the system 200 uses routing protocols to find best route to the target device. Furthermore, at operation 828, the system 200 shares the data with the target device via the best route.

At operation 830, the system 200 determines if the route is optimal. If the output of operation 830 is no, operation 818 is repeated. If the output of operation 830 is yes, status of completion of the data share is shared within the blockchain-based network 806, at operation 832. At operation 834, the system 200 monitors changes in the blockchain-based network 806, routing tables, and the one or more smart contracts. At operation 836, if the applicable one or more smart contracts change with time/data use, the system 200 updates the one or more smart contracts.

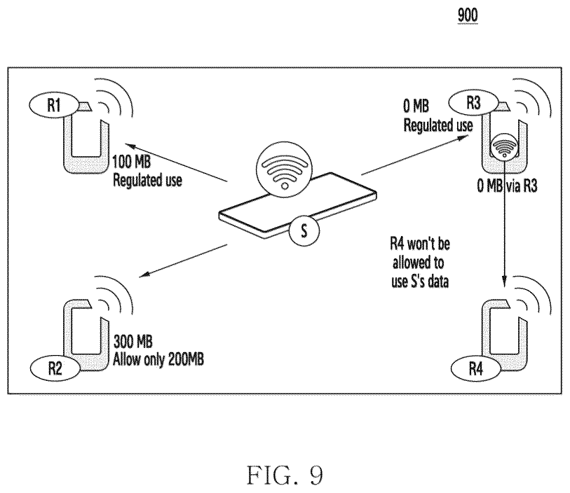

FIG. 9 illustrates a schematic representation 900 of a use case of the system 200 for controlling the communication protocols within the network, according to an embodiment of the disclosure. The details on the working of the system 200 to control the communication protocols within the network have been explained with reference to FIG. 3.

As depicted, S represents a source of hotspot/data source, R1, R2, and R3 are Wi-Fi capable devices connected to the hotspot of S, and R4 represents a Wi-Fi capable device connected to the hotspot of R3 and using data of S. Further, allowed limits are R1 can use 100 MB, R2 can use 200 MB, R3 can use 300 MB, and R4 can only connect but cannot use the data. The system 200 allows regulated access and restriction over data access (separately for separate devices). For example, R1 can use 100 MB, R2 requested 300 MB but it can use 200 MB only, R3 can use 400 MB but used 0 MB, and R4 is not allowed to access S's data even via R3.

In another use case, the system allows S to share data with R1 at a speed of 1 MBS (MB per second) based on the execution of the one or more smart contracts. Further, the system allows S to share data with R2 at a speed of 5 MBS. Furthermore, the system allows S to share data with R3 at a speed of 10 MBS.

In another use case, the system allows S to share data with R1 for a duration of 5 minutes based on the execution of the one or more smart contracts. Further, the system allows S to share data with R2 for a duration of 10 minutes. Furthermore, the system allows S to share data with R3 for a duration of 15 minutes.

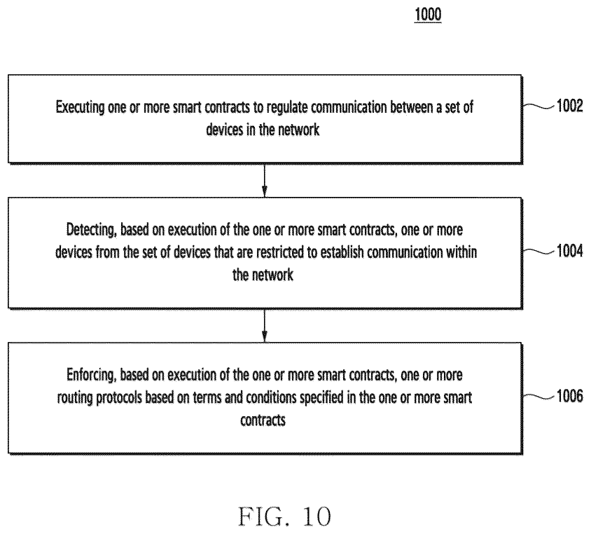

FIG. 10 illustrates a method 1000 for controlling communication protocols within a network based on one or more smart contracts, according to an embodiment of the disclosure. The method 1000 may be performed by a system 200 implemented in the device 202, as shown in FIGS. 2 and 3.

At operation 1002, the method 1000 includes executing one or more smart contracts to regulate communication between a set of devices in the network.

Further, at operation 1004, the method 1000 includes detecting, based on execution of the one or more smart contracts, one or more devices from the set of devices that are restricted to establish communication within the network.

The method further includes restricting the detected one or more devices from establishing the communication within the network.

Further, at operation 1006, the method 1000 includes enforcing, based on execution of the one or more smart contracts, one or more routing protocols, based on at least one of a term or a condition, which is specified in the one or more smart contracts.

While the above operations shown in FIG. 10 are described in a particular sequence, the operations may occur in variations to the sequence in accordance with various embodiments of the disclosure. Further, the details related to various operations of FIG. 10, which are already covered in the description related to FIGS. 2-9 are not discussed again in detail here for the sake of brevity.

The disclosure provides for various technical advancements based on the key features discussed above. The disclosure manages smart contracts to regulate communication (traffic or resource allocation) and data sharing among network of electronic devices. This is followed by restricting devices with Wi-Fi/Bluetooth™ capabilities from establishing communication or data sharing within a network unless authorized by the smart contract. Further, enforcing routing protocols based on the at least one of a term or a condition, which is specified in the smart contract. Thus, the disclosure ensures that even the trusted devices with Wi-Fi capabilities cannot establish communication or data sharing within a hotspot unless authorized by the contract. Further, the disclosure for controlling communication protocols based on smart contracts, enables efficient management and control of network devices by leveraging smart contracts to regulate communication and data sharing. Further, the routing protocol table is (dynamically) updated based on the contractual agreements, enhancing network efficiency and security. The disclosure can be integrated in multiple electronic devices that are present in an environment for optimized network performance based on smart contract and improved user experience. The disclosure controls communication protocol using smart contracts to regulate communication, restrict unauthorized access, and monitor/enforce routing protocols.

Further, the disclosure uses a mechanism to govern how data is shared amongst connected devices to provide more secure and more sophisticated control over data sharing. The disclosure provides users with options, such as limiting the data access by amount, bandwidth, speed, duration, and the like. Furthermore, the disclosure gives more dynamic controls for routing the data to various connected devices. The disclosure optimizes the network performance with the help of the latest routing information based on updated smart contracts. Thus, the disclosure focuses on controlling communication protocols within a network based on smart contracts. The disclosure includes components such as smart contract management, access control, communication routing, and dynamic routing protocol updates. Further, the disclosure ensures authorized device access, regulates communication, and updates routing protocols based on contractual agreements.

Furthermore, the disclosure creates a security and private experience for the users of public Wi-Fi hotspots. The one or more smart contracts are used to control and regulates access of who is allowed to connect to the hotspot, recreate the hotspot, what to share, and what to be encrypted in all communication between devices. As a result, the disclosure prevents unauthorized communication and data sharing between devices. The disclosure uses the one or more smart contracts to control which devices are allowed to connect to the network, and to encrypt all communication between devices. Further, the disclosure controls and regulates the communication protocols between IoT devices, for ensuring secure and authorized data sharing while preventing unauthorized devices from accessing the network. The disclosure discloses a smart contract-based routing protocol that automatically updates the routing table based on the terms of the contract. The disclosure also uses the one or more smart contracts to optimize traffic flow or to ensure that certain devices are always able to communicate with each other. Further, the disclosure uses a Virtual Private Network (VPN) to encrypt all communication between devices, ensuring that it is secure and private. As a result, the disclosure protects sensitive data or helps individuals to protect their privacy.

The plurality of modules 208 may be implemented by any suitable hardware and/or set of instructions. Further, the sequential flow illustrated in FIG. 3 is just an example and the embodiments may include addition/omission of operations as per the requirement. In some embodiments, the one or more operations performed by the plurality of modules 208 may be performed by the one or more processor/controller 204 based on the requirement.

According to an embodiment, a method for controlling communication protocols within a network based on at least one smart contract, comprises executing the at least one smart contract to regulate communication between a set of devices in the network. The method comprises, based on an execution of the at least one smart contract, detecting one or more devices from the set of devices restricted to establish communication within the network, and enforcing one or more routing protocols, based on at least one of a term or a condition, which is specified in the at least one smart contract.

For example, the method comprises at least one of regulating a traffic between the set of devices, based on the execution of the at least one smart contract, allocating one or more resources to the set of devices, based on the execution of the at least one smart contract, regulating data sharing between the set of devices, based on the execution of the at least one smart contract, regulating a bandwidth associated with data sharing between the set of devices, based on the execution of the at least one smart contract, regulating a speed of data sharing between the set of devices, based on the execution of the at least one smart contract, and regulating a duration of data sharing between the set of devices, based on the execution of the at least one smart contract.

For example, the one or more devices correspond to devices with at least one of Wireless Fidelity (Wi-Fi), telecommunication capabilities, and Bluetooth™ capabilities.

For example, the method comprises restricting the detected one or more devices from establishing the communication within the network.

For example, the method comprises receiving a connection request from a new device to join the network, wherein the network is a blockchain-based network. The method comprises generating one or more new smart contracts for the new device, based on the received connection request. The method comprises authenticating an identity of the new device, based on the generated one or more new smart contracts. The method comprises updating one or more routing tables associated with the set of devices upon authenticating the identity of the new device. The method comprises regulating the communication between the set of devices and the new device in the network, based on the updated one or more routing tables.

For example, the method comprises updating one or more routing tables associated with the set of devices within the network, based on changes in the at least one smart contract.

For example, the updating the one or more routing tables comprises detecting at least one of creation, modification, or termination of the at least one smart contract within the network, updating the one or more protocol tables, based on the detected at least one of the creation, the modification, or the termination of the at least one smart contract, and optimizing regulation of communication between the set of devices, based on the updated one or more protocol tables.

According to an embodiment, a system for controlling communication protocols within a network based on at least one smart contract, comprises a memory, and at least one processor operatively coupled to the memory. The at least one processor is configured to execute at least one smart contract to regulate communication between a set of devices in the network. The at least one processor is configured to, based on an execution of the at least one smart contract, detect one or more devices from the set of devices that are restricted to establish communication within the network, and enforce one or more routing protocols based on at least one of a term or a condition, which is specified in the at least one smart contract.

For example, the at least one processor is configured to perform at least one of regulating traffic between the set of devices, based on the execution of the at least one smart contract, allocating one or more resources to the set of devices, based on the execution of the at least one smart contract, regulating data sharing between the set of devices, based on the execution of the at least one smart contract, regulating a bandwidth associated with data sharing between the set of devices, based on the execution of the at least one smart contract, regulating a speed of data sharing between the set of devices, based on the execution of the at least one smart contract, and regulating a duration of data sharing between the set of devices, based on the execution of the at least one smart contract.

For example, the one or more devices correspond to devices with at least one of Wireless Fidelity (Wi-Fi), telecommunication capabilities, and Bluetooth™ capabilities.

For example, the at least one processor is configured to restrict the detected one or more devices from establishing the communication within the network.

For example, the at least one processor is configured to receive a connection request from a new device to join the network, wherein the network is a blockchain-based network. The at least one processor is configured to generate at least one new smart contract for the new device, based on the received connection request. The at least one processor is configured to authenticate an identity of the new device, based on the generated at least one new smart contract. The at least one processor is configured to update one or more routing tables associated with the set of devices upon authenticating the identity of the new device. The at least one processor is configured to regulate the communication between the set of devices and the new device in the network, based on the updated one or more routing tables.

For example, the at least one processor is configured to update one or more routing tables associated with the set of devices within the network, based on changes in the at least one smart contract.

For example, in updating the one or more routing tables, the at least one processor is configured to detect at least one of creation, modification, or termination of the at least one smart contract within the network, update the one or more protocol tables, based on detected at least one of the creation, the modification, or the termination of the at least one smart contract, and optimize regulation of communication between the set of devices, based on the updated one or more protocol tables.

According to an embodiment, a method for controlling communication protocols within a network based on at least one smart contract, comprises executing operations for the at least one smart contract to control communication between a set of devices in the network. The method comprises based on an execution of the operations for the at least one smart contract, detecting one or more devices from the set of devices controlled to establish communication within the network; and performing one or more routing protocols for the one or more devices, based on at least one of a term or a condition, which is specified in the at least one smart contract.

For example, the method comprises at least one of controlling a traffic between the set of devices, based on the execution of the operations for the at least one smart contract, allocating one or more resources to the set of devices, based on the execution of the operations for the at least one smart contract, controlling data sharing between the set of devices, based on the execution of the operations for the at least one smart contract, controlling a bandwidth associated with data sharing between the set of devices, based on the execution of the operations for the at least one smart contract, controlling a speed of data sharing between the set of devices, based on the execution of the operations for the at least one smart contract, and controlling a duration of data sharing between the set of devices, based on the execution of the operations for the at least one smart contract.

For example, the one or more devices correspond to devices with at least one of wireless local area network (WLAN) capabilities, telecommunication capabilities, or short-range wireless communication capabilities.

For example, the method comprises restricting the detected one or more devices from establishing the communication within the network.

For example, the method comprises receiving a connection request from a new device to join the network. The network is a blockchain-based network. The method comprises generating one or more new smart contracts for the new device, based on the received connection request. The method comprises authenticating an identity of the new device, based on the generated one or more new smart contracts. The method comprises updating one or more routing tables associated with the set of devices upon authenticating the identity of the new device. The method comprises controlling the communication between the set of devices and the new device in the network, based on the updated one or more routing tables.

For example, the method comprises updating one or more routing tables associated with the set of devices within the network, based on changes in the at least one smart contract.

For example, the updating the one or more routing tables comprises detecting at least one of creation, modification, or termination of the at least one smart contract within the network, updating the one or more protocol tables, based on the detected at least one of the creation, the modification, or the termination of the at least one smart contract, and optimizing regulation of communication between the set of devices, based on the updated one or more protocol tables.

For example, each of the one or more routing tables comprises information on a protocol, type of route, address of destination, address of another router, interference, time associated with updating.

For example, the at least one smart contract is used for controlling at least one service between the set of devices.

For example, each device of the set of devices comprises ledger for maintaining record of transactions of the set of devices and the at least one smart contract.

According to an embodiment, a system for controlling communication protocols within a network based on at least one smart contract, comprise a memory comprising one or more storage media, storing instructions, and at least one processor comprising processing circuitry. The instructions, when executed by the at least one processor individually or collectively, cause the system to execute operations for at least one smart contract to control communication between a set of devices in the network. The instructions, when executed by the at least one processor individually or collectively, cause the system to based on an execution of the operations for the at least one smart contract, detect one or more devices from the set of devices that are controlled to establish communication within the network, and perform one or more routing protocols for the one or more devices, based on at least one of a term or a condition, which is specified in the at least one smart contract.

For example, the instructions, when executed by the at least one processor individually or collectively, cause the system to perform at least one of controlling traffic between the set of devices, based on the execution of the operations for the at least one smart contract, allocating one or more resources to the set of devices, based on the execution of the operations for the at least one smart contract, controlling data sharing between the set of devices, based on the execution of the operations for the at least one smart contract, controlling a bandwidth associated with data sharing between the set of devices, based on the execution of the operations for the at least one smart contract, controlling a speed of data sharing between the set of devices, based on the execution of the operations for the at least one smart contract, and controlling a duration of data sharing between the set of devices, based on the execution of the operations for the at least one smart contract.

For example, the one or more devices correspond to devices with at least one of wireless local area network (WLAN) capabilities, telecommunication capabilities, or short-range wireless communication capabilities.

For example, the instructions, when executed by the at least one processor individually or collectively, cause the system to restrict the detected one or more devices from establishing the communication within the network.

For example, the instructions, when executed by the at least one processor individually or collectively, cause the system to receive a connection request from a new device to join the network, wherein the network is a blockchain-based network. The instructions, when executed by the at least one processor individually or collectively, cause the system to generate at least one new smart contract for the new device, based on the received connection request. The instructions, when executed by the at least one processor individually or collectively, cause the system to authenticate an identity of the new device, based on the generated at least one new smart contract. The instructions, when executed by the at least one processor individually or collectively, cause the system to update one or more routing tables associated with the set of devices upon authenticating the identity of the new device. The instructions, when executed by the at least one processor individually or collectively, cause the system to control the communication between the set of devices and the new device in the network, based on the updated one or more routing tables.

For example, the instructions, when executed by the at least one processor individually or collectively, cause the system to update one or more routing tables associated with the set of devices within the network, based on changes in the at least one smart contract.

For example, the instructions, when executed by the at least one processor individually or collectively, cause the system to, in updating the one or more routing tables, detect at least one of creation, modification, or termination of the at least one smart contract within the network, update the one or more protocol tables, based on detected at least one of the creation, the modification, or the termination of the at least one smart contract, and optimize regulation of communication between the set of devices, based on the updated one or more protocol tables.

For example, each of the one or more routing tables comprises information on a protocol, type of route, address of destination, address of another router, interference, time associated with updating.

For example, the at least one smart contract is used for controlling at least one service between the set of devices.

According to an embodiment, non-transitory computer readable storage medium stores one or more programs. The one or more programs include instructions which, when executed by at least one processor of an electronic device with communication circuitry, cause the electronic device to execute operations for at least one smart contract to control communication between a set of devices in the network, based on an execution of the operations for the at least one smart contract, detect one or more devices from the set of devices that are controlled to establish communication within the network, and perform one or more routing protocols for the one or more devices, based on at least one of a term or a condition, which is specified in the at least one smart contract.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

For one or more embodiments, at least one of the components set forth in one or more of the preceding figures may be configured to perform one or more operations, techniques, processes, and/or methods as set forth herein. For example, a processor (e.g., baseband processor) as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The methods according to various embodiments described in the claims and/or the specification of the disclosure may be implemented in hardware, software, or a combination of hardware and software.

When implemented by software, a computer-readable storage medium storing one or more programs (software modules) may be provided. One or more programs stored in such a computer-readable storage medium (e.g., non-transitory storage medium) are configured for execution by one or more processors in an electronic device. The one or more programs include instructions that cause the electronic device to execute the methods according to embodiments described in the claims or specification of the disclosure.

Such a program (e.g., software module, software) may be stored in a random-access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other types of optical storage devices, or magnetic cassettes. Alternatively, it may be stored in a memory configured with a combination of some or all of the above. In addition, respective constituent memories may be provided in a multiple number.

Further, the program may be stored in an attachable storage device that can be accessed via a communication network, such as e.g., Internet, Intranet, local area network (LAN), wide area network (WAN), or storage area network (SAN), or a communication network configured with a combination thereof. Such a storage device may access an apparatus performing an embodiment of the disclosure through an external port. Further, a separate storage device on the communication network may be accessed to an apparatus performing an embodiment of the disclosure.

In the above-described specific embodiments of the disclosure, a component included therein may be expressed in a singular or plural form according to a proposed specific embodiment. However, such a singular or plural expression may be selected appropriately for the presented context for the convenience of description, and the disclosure is not limited to the singular form or the plural elements. Therefore, either an element expressed in the plural form may be formed of a singular element, or an element expressed in the singular form may be formed of plural elements.

Meanwhile, specific embodiments have been described in the detailed description of the disclosure, but it goes without saying that various modifications are possible without departing from the scope of the disclosure.

No claim element is to be construed under the provisions of 35 U.S.C. § 112, sixth paragraph, unless the element is expressly recited using the phrase “means for” or “means.”

What is claimed is:

1. A method for controlling communication protocols within a network based on at least one smart contract, the method comprising:
executing operations for the at least one smart contract to control communication between a set of devices in the network;
based on an execution of the operations for the at least one smart contract:
detecting one or more devices from the set of devices controlled to establish communication within the network; and
performing one or more routing protocols for the one or more devices, based on at least one of a term or a condition, which is specified in the at least one smart contract.

2. The method of claim 1, further comprising at least one of:
controlling a traffic between the set of devices, based on the execution of the operations for the at least one smart contract;
allocating one or more resources to the set of devices, based on the execution of the operations for the at least one smart contract;
controlling data sharing between the set of devices, based on the execution of the operations for the at least one smart contract;
controlling a bandwidth associated with data sharing between the set of devices, based on the execution of the operations for the at least one smart contract;
controlling a speed of data sharing between the set of devices, based on the execution of the operations for the at least one smart contract; and
controlling a duration of data sharing between the set of devices, based on the execution of the operations for the at least one smart contract.

3. The method of claim 1, wherein the one or more devices correspond to devices with at least one of wireless local area network (WLAN) capabilities, telecommunication capabilities, or short-range wireless communication capabilities.

4. The method of claim 1, further comprising restricting the detected one or more devices from establishing the communication within the network.

5. The method of claim 1, further comprising:
receiving a connection request from a new device to join the network, wherein the network is a blockchain-based network;
generating one or more new smart contracts for the new device, based on the received connection request;
authenticating an identity of the new device, based on the generated one or more new smart contracts;
updating one or more routing tables associated with the set of devices upon authenticating the identity of the new device; and
controlling the communication between the set of devices and the new device in the network, based on the updated one or more routing tables.

6. The method of claim 1, further comprising updating one or more routing tables associated with the set of devices within the network, based on changes in the at least one smart contract.

7. The method of claim 6, wherein the updating the one or more routing tables comprises:
detecting at least one of creation, modification, or termination of the at least one smart contract within the network;
updating the one or more protocol tables, based on the detected at least one of the creation, the modification, or the termination of the at least one smart contract; and
optimizing regulation of communication between the set of devices, based on the updated one or more protocol tables.

8. The method of claim 6, wherein each of the one or more routing tables comprises information on a protocol, type of route, address of destination, address of another router, interference, time associated with updating.

9. The method of claim 1, wherein the at least one smart contract is used for controlling at least one service between the set of devices.

10. The method of claim 1, wherein each device of the set of devices comprises ledger for maintaining record of transactions of the set of devices and the at least one smart contract.

11. A system for controlling communication protocols within a network based on at least one smart contract, the system comprising:
a memory comprising one or more storage media, storing instructions; and
at least one processor comprising processing circuitry;
wherein the instructions, when executed by the at least one processor individually or collectively, cause the system to:
execute operations for at least one smart contract to control communication between a set of devices in the network;
based on an execution of the operations for the at least one smart contract:
detect one or more devices from the set of devices that are controlled to establish communication within the network; and
perform one or more routing protocols for the one or more devices, based on at least one of a term or a condition, which is specified in the at least one smart contract.

12. The system of claim 11, wherein the instructions, when executed by the at least one processor individually or collectively, cause the system to perform at least one of:
controlling traffic between the set of devices, based on the execution of the operations for the at least one smart contract;
allocating one or more resources to the set of devices, based on the execution of the operations for the at least one smart contract;
controlling data sharing between the set of devices, based on the execution of the operations for the at least one smart contract;
controlling a bandwidth associated with data sharing between the set of devices, based on the execution of the operations for the at least one smart contract;
controlling a speed of data sharing between the set of devices, based on the execution of the operations for the at least one smart contract; and
controlling a duration of data sharing between the set of devices, based on the execution of the operations for the at least one smart contract.

13. The system of claim 11, wherein the one or more devices correspond to devices with at least one of wireless local area network (WLAN) capabilities, telecommunication capabilities, or short-range wireless communication capabilities.

14. The system of claim 11, wherein the instructions, when executed by the at least one processor individually or collectively, cause the system to restrict the detected one or more devices from establishing the communication within the network.

15. The system of claim 11, wherein the instructions, when executed by the at least one processor individually or collectively, cause the system to:
receive a connection request from a new device to join the network, wherein the network is a blockchain-based network;
generate at least one new smart contract for the new device, based on the received connection request;
authenticate an identity of the new device, based on the generated at least one new smart contract;
update one or more routing tables associated with the set of devices upon authenticating the identity of the new device; and
control the communication between the set of devices and the new device in the network, based on the updated one or more routing tables.

16. The system of claim 11, wherein the instructions, when executed by the at least one processor individually or collectively, cause the system to update one or more routing tables associated with the set of devices within the network, based on changes in the at least one smart contract.

17. The system of claim 16, wherein the instructions, when executed by the at least one processor individually or collectively, cause the system to, in updating the one or more routing tables:
detect at least one of creation, modification, or termination of the at least one smart contract within the network;
update the one or more protocol tables, based on detected at least one of the creation, the modification, or the termination of the at least one smart contract; and
optimize regulation of communication between the set of devices, based on the updated one or more protocol tables.

18. The system of claim 16, wherein each of the one or more routing tables comprises information on a protocol, type of route, address of destination, address of another router, interference, time associated with updating.

19. The system of claim 11, wherein the at least one smart contract is used for controlling at least one service between the set of devices.

20. Non-transitory computer readable storage medium storing one or more programs, wherein the one or more programs include instructions which, when executed by at least one processor of an electronic device with communication circuitry, cause the electronic device to:
execute operations for at least one smart contract to control communication between a set of devices in the network;
based on an execution of the operations for the at least one smart contract:
detect one or more devices from the set of devices that are controlled to establish communication within the network; and
perform one or more routing protocols for the one or more devices, based on at least one of a term or a condition, which is specified in the at least one smart contract.
